(19) United States
(12) Patent Application Publication
(10) Pub. No.: US 2017/0088720 A1
(43) Pub. Date: Mar. 30, 2017

(54) COMPOSITION COMPRISING INORGANIC PARTICULATE MATERIAL AND AN POLYMERIC DISPERSANT

(71) Applicant: Imerys Minerals Limited, Par Cornwall (GB)

(72) Inventor: Desmond Charles PAYTON, St. Austell, Cornwall (GB)

(21) Appl. No.: 15/308,312

(22) PCT Filed: May 1, 2015
(86) PCT No.: PCT/GB2015/051274

§ 371 Date: Nov. 1, 2016

(30) Foreign Application Priority Data
May 2, 2014 (GB) 1407798.6

(51) Int. Cl. C09D 7/02; D21H 19/38; C09D 1/00; D21H 19/58

(52) U.S. Cl. CPC C09D 7/02; D21H 19/58; D21H 19/385; C09D 1/00; C08K 3/26

(57) ABSTRACT

An anionic polymeric dispersant and a composition comprising inorganic particulate material and an anionic polymeric dispersant. A method of grinding a composition comprising inorganic particulate material and an anionic polymeric dispersant and a use of anionic polymeric dispersant to maintain the viscosity of a composition comprising inorganic particulate material.

### TECHNICAL FIELD

The present invention relates generally to anionic polymeric dispersants. The present invention also relates to compositions comprising inorganic particulate material and an anionic polymeric dispersant. The present invention further relates to a method of grinding a composition comprising inorganic particulate material and an anionic polymeric dispersant and the use of an anionic polymeric dispersant to maintain the viscosity of a composition comprising inorganic particulate material within an acceptable level.

### BACKGROUND OF THE INVENTION

Aqueous suspensions comprising inorganic particulate material, for example alkaline earth metal carbonate (e.g. calcium carbonate) or kaolin, are used widely in a number of applications. These include, for example, the production of pigment or filler containing compositions which may be used in paper manufacture or paper coating, and the production of filled compositions for paints, plastics and the like.

It is often desirable for the aqueous suspensions to have a relatively high solids content. This often results in aqueous suspensions with high viscosity. In addition, the viscosity of the aqueous suspensions may increase during storage, particularly if they are stored for several days or weeks without stirring.

High viscosity may cause problems during processing (e.g. grinding) of the aqueous suspension, and in handling of the aqueous suspensions after storage. Thus, one or more dispersants are often added to the aqueous suspension, for example before or during processing (e.g. grinding), to assist in processing of the aqueous suspension and/or to maintain the viscosity of the aqueous suspension at an acceptable level during storage. The dispersant may, for example, be an anionic polymeric dispersant (e.g. polyacrylic acid). The anions present on the anionic polymeric dispersant may, for example, be neutralized with one or more neutralizing ions. It may be advantageous to provide an anionic polymeric dispersant which comprises a reduced amount of neutralizing ions.

It may be desirable to provide alternative and/or improved dispersants (e.g. anionic polymeric dispersants) for use in compositions comprising inorganic particulate material. These dispersants (e.g. anionic polymeric dispersants) may, for example, be added to the compositions before or during processing (e.g. during grinding).

It may be desirable to provide a dispersant (e.g. an anionic polymeric dispersant) which at least assists in maintaining the viscosity of an aqueous suspension comprising inorganic particulate material within an acceptable level. In particular, it may be desirable to provide a dispersant (e.g. an anionic polymeric dispersant) which at least assists in maintaining the viscosity of an aqueous suspension comprising inorganic particulate material within an acceptable level during processing (e.g. grinding) and/or during storage. For example, it may be desirable to provide a dispersant (e.g. an anionic polymeric dispersant) which comprises a reduced amount of neutralizing ions, but still assists in maintaining the viscosity of an aqueous suspension comprising inorganic particulate material within acceptable level, for example during processing (e.g. grinding) and/or storage of the composition.

It may also be desirable to provide a dispersant (e.g. an anionic polymeric dispersant) which assists in reducing the viscosity of an aqueous suspension comprising inorganic particulate material, for example during processing (e.g. during grinding) and/or during storage, in comparison to an aqueous suspension comprising a different dispersant (e.g. a different anionic polymeric dispersant). For example, it may be desirable to provide a dispersant (e.g. an anionic polymeric dispersant) which comprises a reduced amount of neutralizing ions but assists in reducing the viscosity of an aqueous suspension comprising inorganic particulate material, for example during processing (e.g. grinding) and/or storage, in comparison to an aqueous suspension comprising a different polymeric dispersant (e.g. a different anionic polymeric dispersant).

### SUMMARY OF THE INVENTION

In accordance with a first aspect of the present invention, there is provided a composition comprising inorganic particulate material and an anionic polymeric dispersant, wherein less than about 40% of the anions present on the polymeric dispersant are neutralized by magnesium ions, about 60% or less of the anions present on the polymeric dispersant are neutralized by sodium ions, and about 70% or less of the anions present on the polymeric dispersant are not neutralized by sodium or magnesium ions, for example wherein about 70% or less of the anions present on the polymeric dispersant are non-neutralized.

In accordance with a further aspect of the present invention, there is provided a composition comprising an inorganic particulate material, an anionic polymeric dispersant and sodium and/or magnesium ions, wherein the ratio of magnesium ions in the composition to anions present on the anionic polymeric dispersant is less than about 2:5 and the ratio of sodium ions in the composition to anions present on the anionic polymeric dispersant is equal to or less than about 3:5. In a further aspect of the present invention, there is provided an anionic polymeric dispersant, wherein the ratio of magnesium ions associated with the dispersant to anionic present on the anionic polymeric dispersant is less than about 2:5 and the ratio of sodium ions associated with the dispersant to anions present on the anionic polymeric dispersant is equal to or less than about 3:5.

In accordance with a further aspect of the present invention, there is provided a composition comprising inorganic particulate material and an anionic polymeric dispersant, wherein the composition has a viscosity ranging from about 100 mPa·s to about 2000 mPa·s up to 7 days after preparation.

In accordance with a second aspect of the present invention, there is provided an anionic polymeric dispersant characterized in that less than about 40% of the anions present on the polymeric dispersant are neutralized by magnesium ions, about 60% or less of the anions present on the polymeric dispersant are neutralized by sodium ions, and about 70% or less of the anions present on the polymeric dispersant are not neutralized by sodium or magnesium ions.

In accordance with a third aspect of the present invention, there is provided a method of grinding a composition comprising inorganic particulate material and an anionic polymeric dispersant, wherein less than about 40% of the anions present on the polymeric dispersant are neutralized by magnesium ions, about 60% or less of the anions present on the polymeric dispersant are neutralized by sodium ions, and about 70% or less of the anions present on the polymeric dispersant are not neutralized by sodium or magnesium ions.

In accordance with a fourth aspect of the present invention, there is provided a use of an anionic polymeric dispersant to maintain the viscosity of a composition comprising an inorganic particulate material within the range of about 100 mPa·s to about 2000 mPa·s, wherein less than about 40% of the anions present on the polymeric dispersant are neutralized by magnesium ions, about 60% or less of the anions present on the polymeric dispersant are neutralized by sodium ions, and about 70% or less of the anions present on the polymeric dispersant are not neutralized by sodium or magnesium ions.

In certain embodiments of any aspect of the present invention, from about 1% to about 39% of the anions present on the polymeric dispersant are neutralized by magnesium ions. For example, from about 5% to about 30% of the anions present on the polymeric dispersant may be neutralized by magnesium ions.

In certain embodiments of any aspect of the present invention, the ratio of magnesium ions in the composition to anions present on the anionic polymeric dispersant ranges from about 1:100 to less than about 2:5, for example from about 1:100 to about 39:100. For example, the ratio of magnesium ions in the composition to anions present on the anionic polymeric dispersant may range from about 5:100 to about 3:10.

In certain embodiments of any aspect of the present invention, from about 1% to about 60% of the anions present on the polymeric dispersant are neutralized by sodium ions. For example, from about 30% to about 60% of the anions present on the polymeric dispersant may be neutralized by sodium ions.

In certain embodiments of any aspect of the present invention, the ratio of sodium ions present in the composition to anions present on the anionic polymeric dispersant ranges from about 1:100 to about 6:10. For example, the ratio of sodium ions present in the composition to anions present on the anionic polymeric dispersant may range from about 3:10 to about 6:10.

In certain embodiments of any aspect of the present invention, from about 1% to about 70% of the anions present on the polymeric dispersant are not neutralized by sodium or magnesium ions. For example, from about 10% to about 50% of anions present on the polymeric dispersant may not be neutralized by sodium or magnesium ions.

In certain embodiments of any aspect of the present invention, the anions present on the polymeric dispersant that are not neutralized by sodium or magnesium ions are at least partially non-neutralized. In certain embodiments, substantially all of the anions present on the polymeric dispersant that are not neutralized by sodium or magnesium ions are non-neutralized.

In certain embodiments of any aspect of the present invention, the inorganic particulate material comprises calcium carbonate. For example, the inorganic particulate material may consist essentially of or consist of calcium carbonate.

In certain embodiments of any aspect of the present invention, the inorganic particulate material comprises calcium carbonate and the anions present on the polymeric dispersant that are not neutralized by sodium or magnesium ions are at least partially neutralized by calcium ions. In certain embodiments, the inorganic particulate material comprises calcium carbonate and substantially all of the anions present on the polymeric dispersant are neutralized by calcium ions.

In certain embodiments of any aspect of the present invention, the anionic polymeric dispersant is a polymer comprising at least one group selected from the group consisting of a hydroxyl group, an amido group, a carboxyl group, a sulfo group, a phosphono group and alkali metal and ammonium salts thereof. In certain embodiments, the anionic polymeric dispersant comprises polyacrylic acid.

In certain embodiments of any aspect of the present invention, the composition has a viscosity ranging from about 100 mPa·s to about 2000 mPa·s immediately after preparation. In alternative embodiments of any aspect of the present invention, the composition has a viscosity ranging from about 100 mPa·s to about 1000 mPa·s or from about 100 mPa·s to about 500 mPa·s up to 7 days after preparation.

In certain embodiments of any aspect of the present invention, the anionic polymeric dispersant is present in an amount ranging from about 0.1 wt % to about 2 wt % based on the total dry weight of the composition.

In certain embodiments of the third or fourth aspect of the present invention, the anionic polymeric dispersant is neutralized with magnesium and/or sodium ions before being combined with the inorganic particulate material. In certain embodiments, the anionic polymeric dispersant is neutralized with magnesium and/or sodium ions during grinding.

In certain embodiments of the third or fourth aspect of the present invention, the inorganic particulate material comprises calcium carbonate and the anions present on the polymeric dispersant that are not neutralized by sodium or magnesium ions become at least partially neutralized by calcium ions during grinding. In certain embodiments of the third aspect of the present invention, the inorganic particulate material comprises calcium carbonate and substantially all of the anions present on the polymeric dispersant that are not neutralized by sodium or magnesium ions become neutralized by calcium ions during grinding.

In certain embodiments of the third or fourth aspect of the present invention, the anionic polymeric dispersant is added incrementally to the inorganic particulate material during grinding.

In certain embodiments of the third or fourth aspect of the present invention, the anionic polymeric dispersant is present in the composition after grinding in an amount ranging from about 0.1 wt % and about 2 wt % based on the total dry weight of the composition.

In certain embodiments of the third or fourth aspect of the present invention, the composition has a viscosity ranging from about 100 mPa·s to about 2000 mPa·s immediately after grinding. In certain embodiments, the composition has a viscosity ranging from about 100 mPa·s to about 500 mPa·s up to 7 days after grinding.

In certain embodiments of the fourth aspect of the present invention, the viscosity of the composition is maintained within the range of about 100 mPa·s to about 500 mPa·s. In certain embodiments, the viscosity of the composition is maintained within the range of about 100 mPa·s to about 300 mPa·s.

In certain embodiments of the fourth aspect of the present invention, the viscosity of the composition comprising inorganic particulate material is maintained during grinding.

In certain embodiments of any aspect of the present invention, the viscosity of the composition comprising inorganic particulate material is maintained during storage. In certain embodiments, the viscosity of the composition is maintained for up to 24 hours after preparation. In certain embodiments, the viscosity of the composition is maintained for up to 7 days after preparation.

Certain embodiments of any aspect of the present invention, may provide one or more of the following advantages:
maintaining the viscosity of a composition comprising inorganic particulate material at an acceptable level, for example an advantageously low level, during grinding;
maintaining the viscosity of a composition comprising inorganic particulate material at an acceptable level, for example an advantageously low level, during storage; and
reducing the amount of neutralizing ions associated with the anionic polymeric dispersant.

The details, examples and preferences provided in relation to any particular one or more of the stated aspects of the present invention apply equally to all aspects of the present invention. Any combination of the embodiments, examples and preferences described herein in all possible variations thereof is encompassed by the present invention unless otherwise indicated herein, or otherwise clearly contradicted by context.

### DETAILED DESCRIPTION OF THE INVENTION

In certain embodiments of the present invention, a composition comprising inorganic particulate material and an anionic polymeric dispersant is provided, which is advantageous in that it demonstrates relatively low viscosity during grinding and/or storage. In certain embodiments of the present invention, a method of grinding is provided, which may, for example, reduce and/or maintain the viscosity of a composition comprising inorganic particulate material, for example during grinding and/or during storage. In certain embodiments of the present invention, a use of an anionic polymeric dispersant is provided, which advantageously maintains the viscosity of a composition comprising inorganic particulate material within an acceptable level, for example during processing (e.g. grinding) or during storage. In certain embodiments of the present invention, an anionic polymeric dispersant which comprises a low or reduced amount of neutralizing ions is provided which is advantageously able to maintain the viscosity of a composition comprising inorganic particulate material within acceptable levels.

In accordance with certain embodiments of the present invention, it has surprisingly been found that the use of an anionic polymeric dispersant in compositions comprising inorganic particulate material, wherein less than about 40% of the anions present on the polymeric dispersant are neutralized by magnesium ions, about 60% or less of the anions present on the polymeric dispersant are neutralized by sodium ions, and about 70% or less of the anions present on the polymeric dispersant are not neutralized by sodium or magnesium ions, results in compositions which demonstrate relatively low viscosity. In certain embodiments, it has been found that these anionic polymeric dispersants can be combined with compositions comprising inorganic particulate material before or during grinding to result in compositions having relatively low viscosity during processing (e.g. grinding) and/or during storage.

### Anionic Polymeric Dispersant and Compositions Comprising Inorganic Particulate Material and an Anionic Polymeric Dispersant

There is provided herein a composition comprising, consisting essentially of or consisting of inorganic particulate material and an anionic polymeric dispersant. The embodiments described herein and all combinations thereof are equally applicable to all aspects of the present invention.

The composition may, for example, be an aqueous suspension. The solids content of the aqueous suspension may, for example, be equal to or greater than about 60% by weight of the composition. For example, the solids content of the composition may be from about 60% to about 85% by weight, for example from about 66% to about 82% by weight, for example from about 70% to about 80% by weight of the composition. For example, the solids content of the composition may be from about 73% to about 79% by weight of the composition, for example the solids content of the composition may be about 76% by weight of the composition. The solids content of the aqueous suspension is the percentage mass of material remaining after the aqueous suspension has been dried to contain zero moisture.

The anionic polymeric dispersant may, for example, be present in a composition comprising inorganic particulate material in an amount ranging from about 0.1 wt % to about 2 wt % based on the total dry weight of the composition. For example, the anionic polymeric dispersant may be present in an amount ranging from about 0.15 wt % to about 2 wt %, for example from about 0.5 wt % to about 1.5 wt %, for example from about 0.5 wt % to about 1.2 wt %. For example, the anionic polymeric dispersant may be present in an amount of about 1 wt %.

A composition comprising inorganic particulate material and an anionic polymeric dispersant may, for example, have a viscosity in the range of about 100 mPa·s to about 2000 mPa·s, for example from about 100 mPa·s to about 1000 mPa·s. For example, a composition comprising inorganic particulate material and an anionic polymer dispersant may have a viscosity in the range of about 100 mPa·s to about 500 mPa·s, for example from about 100 mPa·s to about 300 mPa·s, for example from about 100 mPa·s to about 250 mPa·s. The composition may, for example, have a viscosity in any one of these ranges during processing (e.g. grinding) and/or during storage (e.g. storage for 24 hours, 2 days, 3 days or 7 days after preparation). The mineral slurry may not be subjected to any stirring, mixing or other agitation during storage other than to test the Brookfield viscosity of the composition at intermittent periods of time.

A composition comprising inorganic particulate material and an anionic polymeric dispersant may, for example, have a viscosity in the range of about 100 mPa·s to about 2000 mPa·s, for example from about 100 mPa·s to about 1000 mPa·s immediately after preparation. The composition may, for example, have a viscosity in the range of about 100 mPa·s to about 2000 mPa·s, for example from about 100 mPa·s to about 1000 mPa·s for up to 1 hour after preparation, for up to 24 hours after preparation, for up to 2 days after preparation, for up to 3 days after preparation or for up to 7 days after preparation. A composition comprising inorganic particulate material and an anionic polymeric dispersant may, for example, have a viscosity in the range of about 100 mPa·s to about 500 mPa·s, for example from about 100 mPa·s to about 300 mPa·s immediately after preparation. The composition may, for example, have a viscosity in the range of about 100 mPa·s to about 500 mPa·s, for example from about 100 mPa·s to about 300 mPa·s for up to 1 hour after preparation, for up to 24 hours after preparation, for up to 2 days after preparation, for up to 3 days after preparation or for up to 7 days after preparation. The composition may, for example, have a viscosity in the range of about 100 mPa·s to about 2000 mPa·s, for example from about 100 mPa·s to about 1000 mPa·s, for example from about 100 mPa·s to about 500 mPa·s, for example from about 100 mPa·s to about 300 mPa·s, 24 hours after preparation and/or 2 days after preparation and/or 3 days after preparation and/or 7 days after preparation.

Unless otherwise stated, viscosity is measured using a Brookfield R.V. viscometer or other similar instrument including spindles. Approximately 200 ml of sample is measured into a container. The temperature of the sample is adjusted to 22° C. A clean, dry spindle is immersed into the sample at a central position within the container. The speed is set to 10 rpm and the viscometer is switched on. The speed is then increased to 100 rpm and the spindle is allowed to rotate for 60 seconds±2 seconds. The viscometer reading is then noted.

The composition may, for example, comprise magnesium and/or sodium ions wherein the ratio of magnesium ions in the composition to anions present on the anionic polymeric dispersant is less than about 2:5 and the ratio of sodium ions to anions present on the anionic polymeric dispersant is equal to or less than about 3:5.

For example, the ratio of magnesium ions in the composition to anions present on the anionic polymeric dispersant may range from about 1:100 to less than about 2:5, for example from about 1:100 to about 39:100. For example, the ratio of magnesium ions in the composition to anions present on the anionic polymeric dispersant may range from about 1:100 to about 3:10, for example from about 1:100 to about 2:10. For example, the ratio of magnesium ions in the composition to anions present on the anionic polymeric dispersant may range from about 5:100 to about 3:10, for example from about 5:100 to about 2:10.

In certain embodiments of any aspect of the present invention, the ratio of sodium ions present in the composition to anions present on the anionic polymeric dispersant ranges from about 1:100 to about 6:10. For example, the ratio of sodium ions present in the composition to anions present on the anionic polymeric dispersant may range from about 1:10 to about 6:10, for example from about 2:10 to about 6:10, for example from about 3:10 to about 6:10, for example from about 4:10 to about 6:10. For example, the ratio of sodium ions present in the composition to anions present on the anionic polymeric dispersant may range from about 2:10 to about 5:10, for example from about 3:10 to about 5:10, for example from about 4:10 to about 5:10.

It should be understood that any combination of any of the ratios relating to the presence of sodium and magnesium ions is envisaged by the present invention.

### Inorganic Particulate Material

Any inorganic particulate material capable of being provided in an aqueous suspension may be used in embodiments of the present invention. Suitable inorganic particulate materials may be selected from one or more of the following: alkaline earth metal carbonate (for example dolomite, i.e. CaMg(CO₃)₂), metal sulphate (for example gypsum), metal silicate, metal oxide (for example iron oxide, chromia, antimony trioxide or silica), metal hydroxide, wollastonite, bauxite, talc (for example, French chalk), mica, zinc oxide (for example, zinc white or Chinese white), titanium dioxide (for example, anatase or rutile), zinc sulphide, calcium carbonate (for example precipitated calcium carbonate (PCC), ground calcium carbonate (GCC) or surface-modified calcium carbonate), barium sulphate (for example, barite, blanc fixe or process white), alumina hydrate (for example, alumina trihydrate, light alumina hydrate, lake white or transparent white), clay (for example kaolin, calcined kaolin. China clay or bentonite), and combinations thereof. The inorganic particulate material may be selected from any one or more of the materials listed. The inorganic particulate material may comprise a blend of any combination of the listed materials. Hereinafter, embodiments of the present invention may tend to be discussed in terms of calcium carbonate. However, the invention should not be construed as being limited to such embodiments.

When the inorganic particulate material used in embodiments of the present invention is obtained from naturally occurring sources, it may be that some mineral impurities will inevitably contaminate the ground material. For example, naturally occurring calcium carbonate occurs in association with other minerals. In general, however, the inorganic particulate material used in embodiments of the present invention will contain less than 5% by weight, preferably less than 1% by weight of other mineral impurities.

Calcium carbonate is particularly suitable for use in connection with embodiments of the present invention. Examples of calcium carbonate include ground calcium carbonate (GCC), precipitated calcium carbonate (PCC), dolomite and surface-modified calcium carbonate.

The particulate calcium carbonate used in embodiments of the present invention may be obtained from a natural source by grinding or may be prepared synthetically by precipitation (PCC), or may be a combination of the two, i.e. a mixture of the naturally derived ground material and the synthetic precipitated material. The PCC may also be ground.

Ground calcium carbonate (GCC) is typically obtained by grinding a mineral source such as chalk, marble or limestone, which may be followed by a particle size classification step, in order to obtain a product having the desired degree of fineness.

The particulate solid material may be ground autogenously, i.e. by attrition between the particles of the solid material themselves, or alternatively, in the presence of a particulate grinding medium comprising particles of a different material from the calcium carbonate to be ground.

Wet grinding of calcium carbonate involves the formation of an aqueous suspension of the calcium carbonate which may then be ground, optionally in the presence of a suitable dispersing agent. Reference may be made to, for example, EP-A-614948 (the contents of which are incorporated by reference in their entirety) for more information regarding the wet grinding of calcium carbonate.

PCC may be used as the source of particulate calcium carbonate in embodiments of the present invention, and may be produced by any of the known methods available in the art. TAPPI Monograph Series No 30, “Paper Coating Pigments”, pages 34-35 describes the three main commercial processes for preparing precipitated calcium carbonate which is suitable for use in preparing products for use in the paper industry, but may also be used in connection with the embodiments of the present invention. In all three processes, limestone is first calcined to produce quicklime, and the quicklime is then slaked in water to yield calcium hydroxide or milk of lime. In the first process, the milk of lime is directly carbonated with carbon dioxide gas. This process has the advantage that no by-product is formed, and it is relatively easy to control the properties and purity of the calcium carbonate product. In the second process, the milk of lime is contacted with soda ash to produce, by double decomposition, a precipitate of calcium carbonate and a solution of sodium hydroxide. The sodium hydroxide should be substantially completely separated from the calcium carbonate if this process is to be commercially attractive. In the third main commercial process, the milk of lime is first contacted with ammonium chloride to give a calcium chloride solution and ammonia gas. The calcium chloride solution is then contacted with soda ash to produce, by double decomposition, precipitated calcium carbonate and a solution of sodium chloride.

The process for making PCC results in very pure calcium carbonate crystals and water. The crystals can be produced in a variety of different shapes and sizes, depending on the specific reaction process that is used. The three main forms of PCC crystals are aragonite, rhombohedral and scalenohedral, all of which are suitable for use in embodiments of the present invention, including mixtures thereof.

The calcium carbonate, for example GCC or PCC, may optionally be surface-modified. The calcium carbonate may be coated. The coating may consist of, consist essentially of, or comprise a silane or any salt thereof, for example an organic silane. The calcium carbonate may be coated with a fatty acid or salt thereof. For example, the calcium carbonate may be coated with stearate.

The level of coating may be about 0.1 to about 10 wt % based on the total weight of the coated particulate mineral additive, for example between about 0.1 and about 3 wt %, for example between about 0.5 or 0.6 or 0.7 or 0.8 and about 2.0 wt % e.g. about 1.5 wt %.

The term “coating” used herein is to be understood broadly, and is not limited, for example, to uniform coatings or to coatings which cover the entire surface area of a particle. Particles in which discrete regions of the surface are modified with a coating will be understood as being coated within the terms of certain embodiments of the present invention.

The inorganic particulate material may have a particle size distribution such that about 40 wt % to about 99 wt % of particles are larger than about 1 μm. For example, the inorganic particulate material may have a particle size distribution such that about 50 wt % to about 99 wt %, for example about 60 wt % to about 99 wt % of particles are larger than about 1 μm. For example, the inorganic particulate material may have a particle size distribution within any one of these ranges before the inorganic particulate material or composition comprising inorganic particulate material is ground.

The inorganic particulate material may have a particle size distribution such that about 40 wt % to about 99 wt % of particles are smaller than about 1 μm. For example, the inorganic particulate material may have a particle size distribution such that about 50 wt % to about 99 wt %, for example about 60 wt % to about 99 wt % of particles are smaller than about 1 μm. For example, the inorganic particulate material may have a particle size distribution within any one of these ranges after the inorganic particulate material or composition comprising inorganic particulate material is ground.

Unless otherwise stated, particle size properties referred to herein for the particulate fillers or materials are as measured in a well known manner by sedimentation of the particulate filler or material in a fully dispersed condition in an aqueous medium using a Sedigraph 5100 machine as supplied by Micromeritics Instruments Corporation, Norcross, Ga., USA (telephone: +17706623620; web-site: www.micromeritics.com), referred to herein as a “Micromeritics Sedigraph 5100 unit”. Such a machine provides measurements and a plot of the cumulative percentage by weight of particles having a size, referred to in the art as the ‘equivalent spherical diameter’ (e.s.d), less than given e.s.d values.

### Anionic Polymeric Dispersant

There is provided herein an anionic polymeric dispersant and compositions comprising inorganic particulate material and an anionic polymeric dispersant. The embodiments described herein and all combinations thereof are equally applicable to all aspects of the present invention.

In certain embodiments of any aspect of the invention, the anionic polymeric dispersant may be selected from any polymer capable of being neutralized by one or more cations, for example one or more metal ions. For example, the anionic polymeric dispersant may be selected from any polymer capable of being neutralized by magnesium ions and/or sodium ions and optionally calcium ions.

The anionic polymeric dispersant may, for example, be a polymer comprising at least one group selected from the group consisting of a hydroxyl group, an amido group, a carboxyl group, a sulfo group, a phosphono group and alkali metal and ammonium salts thereof.

The at least one anionic polymeric dispersant may, for example, comprise at least one carboxyl group. For example, the anionic polymeric dispersant may comprise at least one monomeric unit chosen from acrylic acid, methacrylic acid, itaconic acid, crotonic acid, isocrotonic acid, fumaric acid, maleic anhydride, aconitic acid, mesaconic acid, sinapic acid, undecylenic acid, angelic acid, and hydroxyacrylic acid. The anionic polymeric dispersant may be a homopolymer of any one of these monomers or may be a copolymer of any two or more of these monomers. For example, the anionic polymeric dispersant may be polyacrylic acid. The anionic polymeric dispersant may, for example, be a copolymer of any one of these monomers with any allyl, for example any vinyl monomer.

For example, the at least one anionic polymeric dispersant may result from the polymerization of one or more of the monomers selected from acrylic acid, methacrylic acid, itaconic acid, crotonic acid, fumaric acid, maleic anhydride and/or 2-acrylamido-2-methyl-1-propane sulphonic acid in acid form or partially neutralised, 2-methacrylamido-2-methyl-1-propane sulphonic acid in acid form or partially neutralised, 3-methacrylamido-2-hydroxy-1-propane sulphonic acid in acid form or partially neutralised, allylsulphonic acid, methallylsulphonic acid, allyloxybenzene sulphonic acid, methallyloxybenzene sulphonic acid, 2-hydroxy-3-(2-propenyloxy)propane sulphonic acid, 2-methyl-2-propene-1-sulphonic acid, ethylene sulphonic acid, propene sulphonic acid, 2-methyl sulphonic acid, styrene sulphonic acid and/or its salts, vinyl sulphonic acid, sodium methallylsulphonate, sulphopropyl acrylate or methacrylate, sulphomethylacrylamide, sulphomethylmethacrylamide or from acrylamide, methylacrylamide, esters of acrylic or methacrylic acids such as notably ethyl acrylate, butyl acrylate, methyl methacrylate, acrylate or methacrylate phosphate of ethylene or propylene glycol or from amongst vinylpyrrolidone, vinylcaprolactam, isobutylene, diisobutylene, vinyl acetate, styrene, alphamethylstyrene, vinylmethylether, or allyl compounds such as notably allylamine and its derivatives.

For example, the anionic polymeric dispersant may be partially sodium neutralized polymers of acrylic or methacrylic acid or copolymers of acrylic or methacrylic acid with an alkyl acrylate or an alkyl methacrylate, polyacrylamide, poly(vinyl alcohol), and partially sodium neutralized oligostyrenesulfonate can be used. Non-limiting examples include polyacrylates and copolymers, ligosulfonates, and naphthalene sulfonates.

Hereinafter, embodiments of the present invention may tend to be discussed in terms of polyacrylic acid. However, the invention should not be construed as being limited to such embodiments.

The anionic polymeric dispersant may have an average molecular weight of, for example, less than 20,000, ranging, for example, from 1000 to 10,000, such as from 3000 to 9000. For example, the anionic polymeric dispersant may have an average molecular weight from about 4000 to about 6500.

The average molecular weight of the anionic polymeric dispersants may be established by any method known to those skilled in the art. For example, the average molecular weight of the anionic polymeric dispersant may, for example, be determined using colligative property measurements, light scattering techniques, viscometry or size exclusion chromatography.

The anionic polymeric dispersant may, for example, be obtained by providing a commercially available polymer, which may optionally already be partially neutralized with one or more cations, for example sodium ions, and then providing a source of magnesium ions and/or sodium ions and optionally calcium ions in order to obtain an anionic polymeric dispersant having the desired level of neutralization.

The anionic polymeric dispersant may, for example, be obtained by polymerizing one or more monomers, which may optionally already be partially neutralized, using known polymerization techniques to provide an anionic polymeric dispersant, and than providing a source of magnesium ions and/or sodium ions and optionally calcium ions in order to obtain an anionic polymeric dispersant having the desired level of neutralization. The polymer obtained from the polymerization reaction may, for example, be isolated and/or processed and/or separated into several phases before use in the present invention. For example, the polymer may be processed and separated into several phases according to static or dynamic methods known to those skilled in the art, for example by means of one or more polar solvent(s). The polar solvent may, for example, be selected from water, methanol, ethanol, propanol, isopropanol, the butanols, acetone, tetrahydrofuran or mixtures thereof. A particular fraction, for example a fraction having a desired viscosity or molecular weight may then be selected for use in the present invention.

The source of magnesium ions may be any magnesium salt, for example an acetate, carbonate, chloride, citrate, cyanide, fluoride, nitrate, nitrite, phosphate or sulphate of magnesium. The source of magnesium ions may, for example, be magnesium hydroxide. The source of sodium ions may be any sodium salt, for example an acetate, carbonate, chloride, citrate, cyanide, fluoride, nitrate, nitrite, phosphate or sulphate of sodium. The source of sodium ions may, for example, be sodium hydroxide. The source of calcium ions may, for example, be calcium carbonate.

The source of magnesium ions and/or sodium ions may, for example, be provided before the anionic polymeric dispersant is combined with an inorganic particulate material such that the anionic polymeric dispersant has the desired level of neutralization before it is combined with the inorganic particulate material.

The source of magnesium ions and/or sodium ions may, for example, be provided when the anionic polymeric dispersant is already combined with an inorganic particulate material such that the anionic polymeric dispersant reaches the desired level of neutralization after combination with the inorganic particulate material. For example, the source of magnesium ions and/or sodium ions may be provided during processing (e.g. grinding) of the composition comprising inorganic particulate material and an anionic polymeric dispersant such that the anionic polymeric dispersant reaches the desired level of neutralization during processing (e.g. grinding).

The source of magnesium ions and/or sodium ions may, for example, be provided both before and after the anionic polymeric dispersant is combined with the inorganic particulate material. The desired level of neutralization of the anionic polymeric dispersant may be reached before or during processing (e.g. grinding) of the composition comprising inorganic particulate material and an anionic polymeric dispersant.

The anionic polymeric dispersant may, for example, already be partially neutralized with one or more cations, for example sodium ions, before the desired level of neutralization is reached. The provision of a source of magnesium ions and/or sodium ions may replace or add to the neutralization provided by these cations in order to reach the desired level of neutralization either before or after combination with an inorganic particulate material, for example during processing (e.g. grinding) of a composition comprising inorganic particulate material and an anionic polymeric dispersant.

The anionic polymeric dispersant may, for example, be combined with the inorganic particulate material all at once. Alternatively, the anionic polymeric dispersant may, for example, be combined with or added incrementally to the inorganic particulate material during processing (e.g. grinding). For example, the anionic polymeric dispersant may be added at regular intervals and in regular amounts, for example during processing (e.g. grinding).

Less than about 40% of the anions present on the polymeric dispersant may be neutralized by magnesium ions, about 60% or less of the anions present on the polymeric dispersant may be neutralized by sodium ions, and about 70% or less of the anions present on the polymeric dispersant may not be neutralized by sodium or magnesium ions.

The term “anion” may be taken to mean any negatively charged atom or group of atoms. The anions present on the anionic polymeric dispersant that are not neutralized by sodium or magnesium ions may be non-neutralized or may be neutralized by other cations, for example calcium ions.

For example, less than about 40% of the anions present on the polymeric dispersant may be neutralized by magnesium ions. For example, less than about 30%, less than about 25% or less than about 20% of the anions present on the polymeric dispersant may be neutralized by magnesium ions. For example, 0% of the anions present on the polymeric dispersant may be neutralized by magnesium ions.

From about 1% to about 39% of anions present on the polymeric dispersant may, for example, be neutralized by magnesium ions. For example, from about 1% to about 30%, from about 1% to about 25% or from about 1% to about 20% of anions present on the polymeric dispersant may be neutralized by magnesium ions. For example, from about 5% to about 30%, from about 5% to about 25%, from about 5% to about 20% of anions present on the polymeric dispersant may be neutralized by magnesium ions.

About 60% or less of the anions present on the polymeric dispersant may be neutralized by sodium ions. For example, about 55% or less, for example about 50% or less, for example about 45% or less of anions present on the polymeric dispersant may be neutralized by sodium ions.

For example, from about 1% to about 60% of anions present on the polymeric dispersant may be neutralized by sodium ions. For example, from about 10% to about 60% or from about 20% to about 60% of anions present on the polymeric dispersant may be neutralized by sodium ions. For example, from about 30% to about 60% of anions present on the polymeric dispersant may be neutralized with sodium ions. For example, from about 35% to about 60%, from about 40% to about 60% or from about 40% to about 55% of anions present on the polymeric dispersant may be neutralized by sodium ions. For example, from about 30% to about 50% or from about 40% to about 50% of anions present on the polymeric dispersant may be neutralized by sodium ions.

About 70% or less of the anions present on the polymeric dispersant are not neutralized by sodium or magnesium ions. For example, about 65% or less or about 60% or less of the anions present on the polymeric dispersant may not be neutralized by sodium or magnesium ions. For example, about 50% or less of the anions present on the polymeric dispersant may not be neutralized by sodium or magnesium ions. For example, about 45% or less, for example about 40% or less of the anions present on the polymeric dispersant are not neutralized by sodium or magnesium ions.

For example, from about 10% to about 60% of the anions present on the polymeric dispersant may not be neutralized by sodium or magnesium ions. For example, from about 10% to about 50% of the anions present on the polymeric dispersant are not neutralized by sodium or magnesium ions. For example, from about 20% to about 50% of anions present on the polymeric dispersant are not neutralized by sodium or magnesium ions. For example from about 30% to about 50% or from about 40% to about 50% of the anions present on the polymeric dispersant are not neutralized by sodium or magnesium ions.

For example, from about 1% and about 39% of the anions present on the polymeric dispersant may be neutralized by magnesium ions, from about 1% to about 60% of the anions present on the polymeric dispersant may be neutralized by sodium ions, and from about 1% to about 70% of the anions present on the polymeric dispersant may not be neutralized by sodium or magnesium ions.

For example, from about 5% to about 30% of the anions present on the polymeric dispersant are neutralized by magnesium ions, from about 30% to about 60% of the anions present on the polymeric dispersant are neutralized by sodium ions, and from about 10% to about 70% of anions present on the polymeric dispersant are not neutralized by sodium or magnesium ions.

For example, from about 5% to about 30% of the anions present on the polymeric dispersant may be neutralized by magnesium ions, from about 30% to about 60% of the anions present on the polymeric dispersant may be neutralized by sodium ions, and from about 10% to about 50% of the anions present on the polymeric dispersant are not neutralized by sodium or magnesium ions.

For example, from about 10% to about 30% of the anions present on the polymeric dispersant may be neutralized by magnesium ions, from about 40% to about 60% of the anions present on the polymeric dispersant may be neutralized by sodium ions, and from about 20% to about 50% of the anions present on the polymeric dispersant may not be neutralized by sodium or magnesium ions.

For example, from about 40% to about 60% of the anions present on the polymeric dispersant may be neutralized by magnesium ions and from about 40% to about 60% of the anions present on the polymeric dispersant may not be neutralized by sodium or magnesium ions. For example, the inorganic particulate material may be calcium carbonate and from about 40% to about 60% of the anions present on the polymeric dispersant may be neutralized by magnesium ions and the anions present on the polymeric dispersant which are not neutralized with magnesium ions may be neutralized by calcium ions.

It should be understood that any combination of any of the ranges relating to neutralization by sodium and magnesium ions is envisaged by the present invention. A skilled person is able to select any values falling within these ranges that total 100%.

The anions present on the polymeric dispersant that are not neutralized by sodium or magnesium ions may, for example, be at least partially non-neutralized. The term “non-neutralized” may be taken to mean that there is no cation associated with the anion. For example, substantially all of the anions present on the polymeric dispersant that are not neutralized by sodium or magnesium ions are non-neutralized. The term “substantially all” may be taken to mean 95% or more, for example 99% or more, for example 99.5% or more, for example 100%.

The inorganic particulate material may, for example, be calcium carbonate and the anions present on the polymeric dispersant that are not neutralized by sodium or magnesium ions may be at least partially neutralized by calcium ions. For example, the inorganic particulate material may be calcium carbonate and substantially all of the anions present on the polymeric dispersant that are not neutralized by sodium or magnesium ions may be neutralized by calcium ions. The term “substantially all” may be taken to mean 95% or more, for example 99% or more, for example 99.5% or more, for example 100%.

Unless otherwise stated, the level of neutralization of the anionic polymeric dispersant may be measured using an acid-base titration.

### Further Additives

Compositions comprising inorganic particulate material and an anionic polymeric dispersant may optionally comprise further additives. For example, the compositions may further comprise one or more further additives selected from one or more additional dispersing agents, one or more biocides, one or more suspending aids, one or more thickening agents, one or more anti-settling agents one or more salts or one or more other additives.

For example, the one or more additional dispersing agent may be made from monomers and/or co-monomers selected from the group consisting of acrylic acid, methacrylic acid, itaconic acid, crotonic acid, fumaric acid, maleic anhydride acid, isocrotonic acid, aconitic acid (cis or trans), mesaconic acid, sinapinic acid, undecylenic acid, angelic acid, canellic acid, hydroxyacrylic acid, acrolein, acrylamide, acrylonitrile, dimethylaminoethyl methacrylate, vinylpyrrolidone, vinylcaprolactam, ethylene, propylene, isobutylene, diisobutylene, vinyl acetate, styrene, α-methyl styrene, methyl vinyl ketone, the esters of acrylic and methacrylic acids and mixtures thereof.

For example, the one or more biocides may be selected from an aldehyde-releasing biocide, an aldehyde-based biocide, a phenolic biocide, an isothiazoline biocide, or any mixture thereof. The biocide may be selected from one or more of the following: formaldehyde, acetaldehyde, glyoxal, succinaldehyde, glutaraldehyde, 2-propenal, phthalic dialdehyde and mixtures thereof, and in certain embodiments is formaldehyde, glutaraldehyde, benzyl alcoholmono(poly)-hemiformal, ethyleneglycolhemiformal (EGHF), [1,2-Ethanediylbis(oxy)]-bis-methanol, tetrahydro-1,3,4,6-tetrakis(hydroxylmethyl)imidazo [4,5-d]imidazole-2,5 (1H,3H)-dione (also commonly referred to as TetraMethylolAcetyleneDiurea TMAD), orthophenylphenol (OPP), 2-methyl-4-isothiazoline-3-one (MIT), 5-chloro-2-methyl-2H-isothiazolin-3-one (CIT), 1,2-benzisothiazoline-3-one (BIT), or mixtures thereof.

For example, the thickening agent may be selected from polyurethanes, acrylic polymers, latex, styrene, butadiene, polyvinylalcohol, cellulose, cellulose-derived macromolecules, saccharides and organosilicones.

### Method of Grinding

There is provided herein a method of grinding a composition comprising inorganic particulate material and an anionic polymeric dispersant.

The composition comprising inorganic particulate material and an anionic polymeric dispersant and/or the anionic polymeric dispersant disclosed herein includes not only the first and second aspect of the present invention, but also any of the embodiments disclosed herein, including any combination of these embodiments in all possible variations thereof.

The grinding is suitably performed in a conventional manner. The grinding may, for example, be an attrition grinding process in the presence of a particulate grinding medium, or may be an autogenous grinding process, i.e. one in the absence of a grinding medium. The grinding may, for example, be a wet grinding process.

The particulate grinding medium, when present, may be of a natural or a synthetic material. The grinding medium may, for example, comprise balls, beads or pellets of any hard mineral, ceramic or metallic material. Such materials may include, for example, alumina, zirconia, zirconium, silicate, aluminium silicate or the mullite-rich material which is produced by calcining kaolinitic clay at a temperature in the range of from about 1300° C. to about 1800° C. Alternatively, particles of natural sand of a suitable particle size may be used.

Generally, the type of and particle size of grinding medium to be selected for use in the invention may be dependent on the properties, such as, e.g. the particle size of, and the chemical composition of, the feed suspension of inorganic material to be ground. Preferably, the particulate grinding medium comprises particles having an average diameter in the range of from about 0.1 mm to about 6.0 mm and, more preferably in the range of from about 0.2 mm to about 4.0 mm. The grinding medium (or media) may be present in an amount of from about 40% to about 70% by volume of the charge; and, more preferably in an amount from about 50% to about 60% by volume of the charge.

The grinding may be carried out in one or more stages. For example, the feed suspension may be partially ground in a first attrition grinder, the suspension of partially ground inorganic particulate material then being fed to a second attrition grinder for further grinding, after which the suspension of ground material may be fed to one or more subsequent attrition grinders.

After the grinding has been carried out, the suspension may be dewatered to a high solids suspension, and any grinding medium removed.

A high solids suspension formed by said dewatering may suitably have a solids level of the order of 70% or more by weight. One or more additional dispersing agents may optionally be used. The optional dispersing agent used may or may not be the same as the anionic polymeric dispersant described herein. The optional dispersing agent used at the post-grinding stage may be required to restrict flocculation of the particulate inorganic material in the high solids suspension. The optional dispersing agent may therefore be present in a dispersant-effective amount, for example from about 0.3% by weight of dry inorganic particulate, more preferably at least about 0.4% by weight, for example at least about 0.5% by weight.

High solids grinding may be carried out at a calcium carbonate solids content of up to about 78 wt %. When grinding at high solids it is customary to use one or more dispersants. For example, in “Processing of Calcium Carbonates” by S. M. Fortier et al in the 36^{th} Annual Meeting of the Canadian Mineral Processors, held at Ottawa, 20-22 Jan. 2004, and published by The Canadian Institute of Mining. Metallurgy and Petroleum. Paper 11, pages 167 to 175, the contents of which are hereby incorporated by reference in their entirety, methods are described for grinding up to calcium carbonate solids contents of 78 wt %. Also, U.S. Pat. No. 6,003,795, the contents of which are also hereby incorporated by reference in their entirety, describes methods for grinding up to calcium carbonate solids contents of 78 wt % comprising the use of water soluble polycarboxylate dispersing agent, wherein substantially all of the carboxylic acid groups of the polycarboxylate dispersing agent may be in a neutralised state. In particular, the methods described therein and which are useful in the present invention include those where different dispersing agents are used. The different agents may comprise a fully neutralised polycarboxylate salt and an acid form of polycarboxylate which may be added separately, one after the other, or in either order. The basic polymer or copolymer of the different dispersing agents may be the same in each case. Alternatively, a partially neutralised polycarboxylate for use as a dispersing agent may be added at one or more stages. Partially neutralised polycarboxyates are also described in JP55-40715, the contents of which are also incorporated herein, by reference, in their entirety. The degree of neutralisation of the partially neutralised agent may typically be about 30% or less. The partially and fully neutralised polycarboxylates may comprise the same basic polymer. or copolymer, e.g. a sodium polyacrylate. The molecular weight of the sodium polyacrylate may be less than about 20,000 and preferably in the range 700 to 10,000, as measured by the method of gel permeation chromatography using a low angle laser light scattering detector. Typically, the aqueous suspension, during at least one grinding stage, has a pH in the range from 8.5 to 9.8.

U.S. Pat. No. 5,317,053 and U.S. Pat. No. 5,084,254, the contents of which are also hereby incorporated by reference in their entirety, describe suitable methods and dispersants for grinding calcium carbonate for solids contents up to 75 wt %. Suitable dispersants for use in the present invention include an alkali metal, e.g. sodium, or ammonium salt of a poly(acrylic acid) or a poly(methacrylic acid) having, for example, a number average molecular weight not greater than about 10,000. The dispersant is typically present up to about 1 wt %, for example, 0.05 to 1 wt %, based on the dry weight of the inorganic particulate material.

The anionic polymeric dispersant may, for example, be combined with the inorganic particulate material all at once at the beginning of the grind. Alternatively, the anionic polymeric dispersant may, for example, be added incrementally to the inorganic particulate material during grinding. For example, the anionic polymeric dispersant may be added at regular intervals and in regular amounts during grinding.

The anionic polymeric dispersant may, for example, be present in the composition after grinding in an amount ranging from about 0.1 wt % to about 2 wt % based on the total dry weight of the composition. For example, the anionic polymeric dispersant may be present in an amount ranging from about 0.15 wt % to about 2 wt %, for example from about 0.5 wt % to about 1.5 wt %, for example from about 0.5 wt % to about 1.2 wt %. For example, the anionic polymeric dispersant may be present in an amount of about 1 wt %.

The anionic polymeric dispersant may, for example, be neutralized with magnesium and/or sodium ions before being combined with the inorganic particulate material. For example, the anionic polymeric dispersant may reach the desired level of neutralization by magnesium ions and/or sodium ions before being combined with the inorganic particulate material.

The anionic polymeric dispersant may, for example, be neutralized with magnesium and/or sodium ions after being combined with the inorganic particulate material in order to reach the desired level of neutralization by magnesium ions and/or sodium ions. For example, the anionic polymeric dispersant may reach the desired level of neutralization by magnesium ions and/or sodium ions during grinding of the composition comprising inorganic particulate material and an anionic polymeric dispersant.

The anionic polymeric dispersant may, for example, be partially neutralized with magnesium and/or sodium ions before being combined with the inorganic particulate material and then reaches the desired level of neutralization after being combined with the inorganic particulate material. For example, the anionic polymeric dispersant may reach the desired level of neutralization by magnesium and/or sodium ions during grinding of the composition comprising inorganic particulate material and an anionic polymeric dispersant.

Where the anions present on the inorganic particulate material that are not neutralized by sodium or magnesium ions are at least partially or substantially completely neutralized by calcium ions, the anionic polymeric dispersant may reach the desired level of neutralization by calcium ions after being combined with calcium carbonate. For example, the anionic polymeric dispersant may reach the desired level of neutralization by calcium ions during grinding of the composition comprising inorganic particulate material and an anionic polymeric dispersant. The desired level of neutralization by calcium ions may, for example, be wherein the anions present on the polymeric dispersant that are not neutralized by sodium or magnesium ions are at least partially neutralized by calcium ions. For example, the desired level of neutralization by calcium ions may be wherein substantially all of the anions present on the polymeric dispersant that are not neutralized by sodium or magnesium ions are neutralized by calcium ions.

Where the desired level of neutralization by magnesium ions and/or sodium ions is reached during grinding of the composition comprising inorganic particulate material and an anionic polymeric dispersant, a source of magnesium and/or sodium ions may be combined with the composition during grinding.

The source of magnesium ions may be any magnesium salt, for example an acetate, carbonate, chloride, citrate, cyanide, fluoride, nitrate, nitrite, phosphate or sulphate of magnesium. The source of magnesium ions may, for example, be magnesium hydroxide. The source of sodium ions may be any sodium salt, for example an acetate, carbonate, chloride, citrate, cyanide, fluoride, nitrate, nitrite, phosphate or sulphate of sodium. The source of sodium ions may, for example, be sodium hydroxide. The source of calcium ions may, for example, be calcium carbonate.

### Use of Anionic Polymeric Dispersant to Maintain Viscosity

There is provided herein a use of an anionic polymeric dispersant to maintain the viscosity of a composition comprising inorganic particulate material within an acceptable level.

The composition comprising inorganic particulate material and an anionic polymeric dispersant and/or the anionic polymeric dispersant disclosed herein includes not only the first and second aspect of the present invention, but also any of the embodiments disclosed herein, including any combination of these embodiments in all possible variations thereof.

The anionic polymeric dispersant may be used to maintain the viscosity of a composition comprising inorganic particulate material within the range of about 100 mPa·s to about 2000 mPa·s. For example, the anionic polymeric dispersant may be used to maintain the viscosity of the composition within the range of about 100 mPa·s to about 1000 mPa·s. For example, the anionic polymeric dispersant may be used to maintain the viscosity of the composition within the range of about 100 mPa·s to about 500 mPa·s, for example from about 100 mPa·s to about 300 mPa·s, for example from about 100 mPa·s to about 250 mPa·s. The viscosity may, for example, be maintained within any one of these ranges during processing (e.g. grinding) and/or during storage of the composition (e.g. storage for 24 hours, 2 days, 3 days or 7 days after preparation). The mineral slurry may not be subjected to any stirring, mixing or other agitation during storage other than to test the Brookfield viscosity of the composition at intermittent periods of time.

The anionic polymeric dispersant may be used to maintain the viscosity of a composition within the range of about 100 mPa·s to about 2000 mPa·s, for example from about 100 mPa·s to about 1000 mPa·s immediately after preparation (e.g. immediately after grinding). The anionic polymeric dispersant may, for example, be used to maintain the viscosity in the range of about 100 mPa·s to about 2000 mPa·s, for example from about 100 mPa·s to about 1000 mPa·s for up to 1 hour after preparation, for up to 24 hours after preparation, for up to 2 days after preparation, for up to 3 days after preparation or for up to 7 days after preparation.

The anionic polymeric dispersant may be used to maintain the viscosity of a composition comprising inorganic particulate material within the range of about 100 mPa·s to about 500 mPa·s, for example from about 100 mPa·s to about 300 mPa·s, for example from about 100 mPa·s to about 250 mPa·s immediately after preparation (e.g. immediately after grinding). The anionic polymeric dispersant may, for example, be used to maintain the viscosity of the composition within the range of about 100 mPa·s to about 500 mPa·s, for example from about 100 mPa·s to about 300 mPa·s, for example from about 100 mPa·s to about 250 mPa·s for up to 1 hour after preparation, for up to 24 hours after preparation, for up to 2 days after preparation, for up to 3 days after preparation or for up to 7 days after preparation. The anionic polymeric dispersant may be used to maintain the viscosity of a composition within the range of about 100 mPa·s to about 2000 mPa·s, for example from about 100 mPa·s to about 1000 mPa·s, for example from about 100 mPa·s to about 500 mPa·s, for example from about 100 mPa·s to about 300 mPa·s, for 24 hours and/or for 2 days and/or for 3 days and/or for 7 days after preparation.

The viscosity of the composition comprising inorganic particulate material and an anionic polymeric dispersant may be maintained during processing (e.g. during grinding) of the composition.

The viscosity of a composition comprising inorganic particulate material and an anionic inorganic dispersant may be measured using a Brookfield R.V. viscometer as described above.

The anionic polymeric dispersant may, for example, be combined with the inorganic particulate material before, during or after processing of the composition (e.g. grinding).

Alternatively and/or additionally, the viscosity of the composition comprising inorganic particulate material and an anionic polymeric dispersant may be maintained during storage of the composition. For example, the viscosity of the composition may be maintained during storage of the composition without stirring mixing or other agitation except to test the Brookfield viscosity of the composition at intermittent periods of time during storage. In certain embodiments, the viscosity of the composition may be maintained during storage of the composition for a period of up to 1 hour, for example up to 24 hours, for example up to 48 hours, for example up to 72 hours. In certain embodiments, the viscosity of the composition may be maintained during storage of the composition for a period up to 1 week, for example up to 2 weeks, for example up to 3 weeks, for example up to 4 weeks. In certain embodiments, the viscosity of the composition may be maintained during storage of the composition for a period up to 1 month, for example up to 2 months, for example up to 3 months, for example up to 4 months, for example up to 5 months, for example up to 6 months.

The anionic polymeric dispersant may, for example, be neutralized with magnesium and/or sodium ions before being combined with the inorganic particulate material. For example, the anionic polymeric dispersant may reach the desired level of neutralization by magnesium ions and/or sodium ions before being combined with the inorganic particulate material.

The anionic polymeric dispersant may, for example, be neutralized with magnesium and/or sodium ions after being combined with the inorganic particulate material in order to reach the desired level of neutralization by magnesium ions and/or sodium ions. For example, the anionic polymeric dispersant may reach the desired level of neutralization by magnesium ions and/or sodium ions during grinding of the composition comprising inorganic particulate material and an anionic polymeric dispersant.

The anionic polymeric dispersant may, for example, be partially neutralized with magnesium and/or sodium ions before being combined with the inorganic particulate material and then reaches the desired level of neutralization after being combined with the inorganic particulate material. For example, the anionic polymeric dispersant may reach the desired level of neutralization by magnesium and/or sodium ions during grinding of the composition comprising inorganic particulate material and an anionic polymeric dispersant.

The foregoing broadly describes certain embodiments of the present invention without limitation. Variations and modifications as will be readily apparent to those skilled in the art are intended to be within the scope of the present invention as defined in and by the appended claims.

### Examples

### Example 1

Aqueous suspensions comprising calcium carbonate having 90 wt % of particles smaller than 2 μm and a polyacrylic acid were prepared.

The calcium carbonate was ground to obtain 90 wt % of particles smaller than 2 μm using a lab media grinder.

The polyacrylic acid used was a commercially available partially sodium-neutralized polyacrylic acid with an average molecular weight between 4000 and 6500. The polyacrylic acid was further neutralized by sodium and magnesium ions using magnesium hydroxide and sodium hydroxide to obtain a target ratio. The degree of neutralization was measured by an acid base titration. Magnesium hydroxide was added and the level of neutralization by magnesium ions was determined followed by addition of sodium hydroxide and measurement of the level of neutralization by sodium ions, in order to reach the desired level of neutralization.

The compositions shown in table 1 below were obtained. The viscosity of these compositions immediately after preparation (T0), one hour after preparation (T1), 24 hours after preparation (T24) and 168 hours after preparation (T168) was determined using a Brookfield R.V. viscometer as described above. The results are shown in table 1.

TABLE 1

| | | | Active | | | | | |
|---|---|---|---|---|---|---|---|---|
| | | | Dispersant | | | | | |
| | | | (wt % | | | | | |
| | | | based on | | | | | |
| | | | dry | Solids | Brookfield Viscosity | | | |
| Ratio (%) | | | calcium | Content | B100 (mPa · s) | | | |
| Mg | Na | Acid | carbonate) | (wt %) | T0 | T1 | T24 | T168 |
| 40 | 60 | 0 | 1 | 76.1 | 172 | 195 | 225 | 260 |
| 30 | 70 | 0 | 1 | 75.9 | 185 | 240 | 435 | 455 |
| 8 | 31 | 62 | 1 | 76.0 | 130 | 140 | 150 | 160 |
| 28 | 49 | 23 | 1 | 76.1 | 150 | 170 | 205 | 220 |
| 36 | 60 | 4 | 1 | 75.9 | 150 | 173 | 235 | 265 |
| 34 | 59 | 8 | 1 | 76.1 | 190 | 210 | 245 | 285 |
| 32 | 59 | 9 | 1 | 75.9 | 180 | 200 | 240 | 278 |
| 30 | 59 | 11 | 1 | 76.0 | 165 | 190 | 230 | 255 |
| 28 | 58 | 14 | 1 | 76.0 | 160 | 180 | 228 | 250 |
| 20 | 57 | 23 | 1 | 76.0 | 165 | 177 | 190 | 205 |
| 8 | 36 | 55 | 1 | 76 | 240 | 290 | 365 | 550 |
| 16 | 42 | 42 | 1 | 76 | 160 | 180 | 200 | 250 |
| 14 | 41 | 45 | 1 | 76 | 170 | 180 | 200 | 245 |
| 0 | 55 | 45 | 0.8 | 76 | 168 | 180 | 210 | 240 |
| 0 | 53 | 47 | 0.6 | 75.9 | 140 | 160 | 200 | 210 |
| 0 | 40 | 60 | 1 | 76.0 | 165 | 185 | 235 | 255 |

The foregoing broadly describes certain embodiments of the present invention without limitation. Variations and modifications as will be readily apparent to those skilled in the art are intended to be within the scope of the present invention as defined in and by the appended claims.

The following numbered paragraphs define particular embodiments of the present invention:
1. A composition comprising inorganic particulate material and an anionic polymeric dispersant, wherein:
   less than about 40% of the anions present on the polymeric dispersant are neutralized by magnesium ions,
   about 60% or less of the anions present on the polymeric dispersant are neutralized by sodium ions, and
   about 70% or less of the anions present on the polymeric dispersant are not neutralized by sodium or magnesium ions.
2. The composition of paragraph 1, wherein from about 1% to about 39% of the anions present on the polymeric dispersant are neutralized by magnesium ions.
3. The composition of paragraph 1 or 2, wherein from about 5% to about 30% of the anions present on the polymeric dispersant are neutralized by magnesium ions.
4. The composition of any one of paragraphs 1 to 3, wherein from about 1% to about 60% of the anions present on the polymeric dispersant are neutralized by sodium ions.
5. The composition of any one of paragraphs 1 to 4, wherein from about 30% to about 60% of the anions present on the polymeric dispersant are neutralized by sodium ions.
6. The composition of any one of paragraphs 1 to 5, wherein from about 1% to about 70% of the anions present on the polymeric dispersant are not neutralized by sodium or magnesium ions.
7. The composition of any one of paragraphs 1 to 6, wherein from about 10% to about 50% of anions present on the polymeric dispersant are not neutralized by sodium or magnesium ions.
8. The composition of any one of paragraphs 1 to 7, wherein the anions present on the polymeric dispersant that are not neutralized by sodium or magnesium ions are at least partially non-neutralized.
9. The composition of any one of paragraphs 1 to 8, wherein substantially all of the anions present on the polymeric dispersant that are not neutralized by sodium or magnesium ions are non-neutralized.
10. The composition of any one of paragraphs 1 to 8, wherein the inorganic particulate material comprises calcium carbonate.
11. The composition of paragraph 10, wherein the anions present on the polymeric dispersant that are not neutralised by sodium or magnesium ions are at least partially neutralized by calcium ions.
12. The composition of paragraph 10 or 11, wherein substantially all of the anions present on the polymeric dispersant that are not neutralised by sodium or magnesium ions are neutralized by calcium ions.
13. The composition of any one of paragraphs 1 to 12, wherein the anionic polymeric dispersant is a polymer comprising at least one group selected from the group consisting of a hydroxyl group, an amido group, a carboxyl group, a sulfo group, a phosphono group and alkali metal and ammonium salts thereof.
14. The composition of any one of paragraphs 1 to 13, wherein the anionic polymeric dispersant comprises polyacrylic acid.
15. The composition of any one of paragraphs 1 to 14, wherein the composition has a viscosity ranging from about 100 mPa·s to about 2000 mPa·s immediately after preparation.
16. The composition of any one of paragraphs 1 to 15, wherein the composition has a viscosity ranging from about 100 mPa·s to about 500 mPa·s up to 7 days after preparation.
17. The composition of any one of paragraphs 1 to 16, wherein the anionic polymeric dispersant is present in an amount ranging from about 0.1 wt % to about 2 wt % based on the total dry weight of the composition.
18. An anionic polymeric dispersant characterized in that:
   less than about 40% of the anions present on the polymeric dispersant are neutralized by magnesium ions,
   about 60% or less of the anions present on the polymeric dispersant are neutralized by sodium ions, and
   about 70% or less of the anions present on the polymeric dispersant are not neutralized by sodium or magnesium ions.
19. The anionic polymeric dispersant of paragraph 18, wherein from about 1% to about 39% of the anions present on the polymeric dispersant are neutralized by magnesium ions.
20. The anionic polymeric dispersant of paragraph 18 or 19, wherein from about 5% to about 30% of the anions present on the polymeric dispersant are neutralized by magnesium ions.
21. The anionic polymeric dispersant of any one of paragraphs 18 to 20, wherein from about 1% to about 60% of the anions present on the polymeric dispersant are neutralized by sodium ions.
22. The anionic polymeric dispersant of any one of paragraphs 18 to 21, wherein from about 30% to about 60% of the anions present on the polymeric dispersant are neutralized by sodium ions.
23. The anionic polymeric dispersant of any one of paragraphs 18 to 22, wherein from about 1% to about 70% of the anions present on the polymeric dispersant are not neutralized by sodium or magnesium ions.
24. The anionic polymeric dispersant of any one of paragraphs 18 to 23, wherein from about 10% to about 50% of the anions present on the polymeric dispersant are not neutralized by sodium or magnesium ions.
25. The anionic polymeric dispersant of any one of paragraphs 18 to 24, wherein the anions present on the polymeric dispersant that are not neutralized by sodium or magnesium ions are at least partially non-neutralized.
26. The anionic polymeric dispersant of any one of paragraphs 18 to 25, wherein substantially all of the anions present on the polymeric dispersant that are not neutralized by sodium or magnesium ions are non-neutralized.
27. The anionic polymeric dispersant of any one of paragraphs 18 to 26, wherein the anionic polymeric dispersant is a polymer comprising at least one group selected from the group consisting of a hydroxyl group, an amido group, a carboxyl group, a sulfo group, a phosphono group and alkali metal and ammonium salts thereof.
28. The anionic polymeric dispersant of any one of paragraphs 18 to 27, wherein the anionic polymeric dispersant comprises polyacrylic acid.
29. A method of grinding a composition comprising inorganic particulate material and an anionic polymeric dispersant, wherein less than about 40% of the anions present on the polymeric dispersant are neutralized by magnesium ions, about 60% or less of the anions present on the polymeric dispersant are neutralized by sodium ions, and about 70% or less of the anions present on the polymeric dispersant are not neutralized by sodium or magnesium ions.
30. The method of paragraph 29, wherein the anionic polymeric dispersant is neutralized with magnesium and/or sodium ions before being combined with the inorganic particulate material.
31. The method of paragraph 29, wherein the anionic polymeric dispersant is neutralized with magnesium and/or sodium ions during grinding.
32. The method of any one of paragraphs 29 to 31, wherein the inorganic particulate material comprises calcium carbonate.
33. The method of paragraph 32, wherein the anions present on the polymeric dispersant that are not neutralized by sodium or magnesium ions become at least partially neutralized by calcium ions during grinding.
34. The method of paragraph 32 or 33, wherein substantially all of the anions present on the polymeric dispersant that are not neutralized by sodium or magnesium ions become neutralized by calcium ions during grinding.
35. The method of any one of paragraphs 29 to 34, wherein the anionic polymeric dispersant is added incrementally to the inorganic particulate material during grinding.
36. The method of any one of paragraphs 29 to 35, wherein the anionic polymeric dispersant is present in the composition after grinding in an amount ranging from about 0.1 wt % to about 2 wt % based on the total dry weight of the composition.
37. The method of any one of paragraphs 29 to 36, wherein from about 1% to about 39% of the anions present on the polymeric dispersant are neutralized by magnesium ions.
38. The method of any one of paragraphs 29 to 37, wherein from about 5% to about 30% of the anions present on the polymeric dispersant are neutralized by magnesium ions.
39. The method of any one of paragraphs 29 to 38, wherein from about 1% to about 60% of the anions present on the polymeric dispersant are neutralized by sodium ions.
40. The method of any one of paragraphs 29 to 39, wherein from about 30% to about 60% of the anions present on the polymeric dispersant are neutralized by sodium ions.
41. The method of any one of paragraphs 29 to 40, wherein from about 1% to about 70% of the anions present on the polymeric dispersant are not neutralized by sodium or magnesium ions.
42. The method of any one of paragraphs 29 to 41, wherein from about 10% to 50% of the anions present on the polymeric dispersant are not neutralized by sodium or magnesium ions.
43. The method of any one of paragraphs 29 to 42, wherein the anions present on the polymeric dispersant that are not neutralized by sodium or magnesium ions are at least partially non-neutralized.
44. The method of any one of paragraphs 29 to 42, wherein substantially all of the anions present on the polymeric dispersant that are not neutralized by sodium or magnesium ions are non-neutralized.
45. The method of any one of paragraphs 29 to 42, wherein the anionic polymeric dispersant is a polymer comprising at least one group selected from the group consisting of a hydroxyl group, an amido group, a carboxyl group, a sulfo group, a phosphono group and alkali metal and ammonium salts thereof.
46. The method of any one of paragraphs 29 to 45, wherein the anionic polymeric dispersant comprises polyacrylic acid.
47. The method of any one of paragraphs 29 to 46, wherein the composition has a viscosity ranging from about 100 mPa·s to about 2000 mPa·s immediately after grinding.
48. The method of any one of paragraphs 29 to 47, wherein the composition has a viscosity ranging from about 100 mPa·s to about 500 mPa·s up to 7 days after grinding.
49. Use of an anionic polymeric dispersant to maintain the viscosity of a composition comprising inorganic particulate material within the range of about 100 mPa·s to about 2000 mPa·s, wherein
   less than about 40% of the anions present on the polymeric dispersant are neutralized by magnesium ions,
   about 60% or less of the anions present on the polymeric dispersant are neutralized by sodium ions, and
   about 70% or less of the anions present on the polymeric dispersant are not neutralized by sodium or magnesium ions.
50. The use of paragraph 49, wherein the viscosity of the composition is maintained within the range of about 100 mPa·s to about 500 mPa·s.
51. The use of paragraph 49 or 50, wherein the viscosity of the composition is maintained within the range of about 100 mPa·s to about 300 mPa·s.
52. The use of any one of paragraphs 49 to 51, wherein the viscosity of the composition is maintained during grinding.
53. The use of any one of paragraphs 49 to 52, wherein the viscosity of the composition is maintained during storage.
54. The use of paragraph 53, wherein the viscosity of the composition is maintained for up to 24 hours after preparation.
55. The use of paragraphs 53 or 54, wherein the viscosity of the composition is maintained for up to 7 days after preparation, for example for up to 2 weeks after preparation, for example for up to 3 weeks after preparation, for example up to 4 weeks after preparation.
56. The use of any one of paragraphs 49 to 55, wherein from about 1% to about 39% of the anions present on the polymeric dispersant are neutralized by magnesium ions.
57. The use of any one of paragraphs 49 to 56, wherein from about 5% to about 30% of the anions present on the polymeric dispersant are neutralized by magnesium ions.
58. The use of any one of paragraphs 49 to 57, wherein from about 1% to about 60% of the anions present on the polymeric dispersant are neutralized by sodium ions.
59. The use of any one of paragraphs 49 to 58, wherein from about 30% to about 60% of the anions present on the polymeric dispersant are neutralized by sodium ions.
60. The use of any one of paragraphs 49 to 59, wherein from about 1% to about 70% of the anions present on the polymeric dispersant are not neutralized by sodium or magnesium ions.
61. The use of any one of paragraphs 49 to 60, wherein from about 10% to about 50% of the anions present on the polymeric dispersant are not neutralized by sodium or magnesium ions.
62. The use of any one of paragraphs 49 to 61, wherein the anions present on the polymeric dispersant that are not neutralized by sodium or magnesium ions are at least partially non-neutralized.
63. The use of any one of paragraphs 49 to 62, wherein substantially all of the anions present on the polymeric dispersant that are not neutralized by sodium or magnesium ions are non-neutralized.
64. The use of any one of paragraphs 49 to 63, wherein the inorganic particulate material comprises calcium carbonate.
65. The use of paragraph 64, wherein the anions present on the polymeric dispersant that are not neutralized by sodium or magnesium ions are at least partially neutralized by calcium ions.
66. The use of paragraph 64 or 65, wherein substantially all of the anions present on the polymeric dispersant that are not neutralized by sodium or magnesium ions are neutralized by calcium ions.
67. The use of any one of paragraphs 49 to 66, wherein the anionic polymeric dispersant is a polymer comprising at least one group selected from the group consisting of a hydroxyl group, an amido group, a carboxyl group, a sulfo group, a phosphono group and alkali metal and ammonium salts thereof.
68. The use of any one of paragraphs 49 to 67, wherein the anionic polymeric dispersant comprises polyacrylic acid.
69. The use of any one of paragraphs 49 to 68, wherein the anionic polymeric dispersant is present in the composition in a total amount ranging from about 0.1 wt % and about 2 wt % based on the total dry weight of the composition.
70. A composition comprising inorganic particulate material and an anionic polymeric dispersant, wherein the composition has a viscosity ranging from about 100 mPa·s to about 2000 mPa·s up to 7 days after preparation.
71. The composition of paragraph 70, wherein the composition has a viscosity ranging from about 100 mPa·s to about 1000 mPa·s up to 7 days after preparation.
72. The composition of paragraph 70 or 71, wherein the composition has a viscosity ranging from about 100 mPa·s to about 500 mPa·s, for example from about 100 mPa·s to about 300 mPa·s up to 7 days after preparation.
73. The composition of any one of paragraphs 70 to 72, wherein the composition has a viscosity ranging from about 100 mPa·s to about 2000 mPa·s up to 2 weeks after preparation, for example up to 3 weeks after preparation, for example up to 4 weeks after preparation.
74. The composition of any one of paragraphs 1 to 17 or 70 to 73, the method of any one of paragraphs 29 to 48 or the use of any one of paragraphs 49 to 69, wherein the composition has a solids content equal to or greater than about 60% by weight of the composition.
75. The composition of any one of paragraphs 1 to 17 or 70 to 74, the method of any one of paragraphs 29 to 48 or the use of any one of paragraphs 49 to 69, wherein the composition has a solids content ranging from about 70% to about 80% by weight of the composition.
76. The composition of any one of paragraphs 70 to 75, wherein the composition is as defined in any one of paragraphs 1 to 17.

1. A composition comprising inorganic particulate material and an anionic polymeric dispersant, wherein:
less than about 40% of the anions present on the polymeric dispersant are neutralized by magnesium ions;
about 60% or less of the anions present on the polymeric dispersant are neutralized by sodium ions; and
about 70% or less of the anions present on the polymeric dispersant are not neutralized by sodium or magnesium ions.

2. The composition of claim 1, wherein from about 1% to about 39% of the anions present on the polymeric dispersant are neutralized by magnesium ions.

3. The composition of claim 1, wherein from about 1% to about 60% of the anions present on the polymeric dispersant are neutralized by sodium ions.

4. The composition of claim 1, wherein from about 1% to about 70% of the anions present on the polymeric dispersant are not neutralized by sodium or magnesium ions.

5. The composition of claim 1, wherein the inorganic particulate material comprises calcium carbonate.

6. The composition of claim 5, wherein substantially all of the anions present on the polymeric dispersant that are not neutralized by sodium or magnesium ions are neutralized by calcium ions.

7. The composition of claim 1, wherein the anionic polymeric dispersant comprises polyacrylic acid.

8. The composition of claim 1, wherein the composition has a viscosity ranging from about 100 mPa·s to about 2000 mPa·s immediately after preparation.

9. The composition of claim 1, wherein the composition has a viscosity ranging from about 100 mPa·s to about 500 mPa·s up to 7 days after preparation.

10. The composition of claim 1, wherein the composition is an anionic polymeric dispersant.

11. A method of grinding a composition comprising, providing a composition comprising an inorganic particulate material and an anionic polymeric dispersant as defined in claim 1, and grinding the composition.

12. A method of maintaining the viscosity of a composition comprising: providing a composition comprising an inorganic particulate material and an anionic polymeric dispersant as defined in claim 1, and controlling the amount of the anionic polymeric dispersant to maintain the viscosity of the composition within the range of about 100 mPa·s to about 2000 mPa·s.

13. A composition comprising inorganic particulate material and an anionic polymeric dispersant, wherein the composition has a viscosity ranging from about 100 mPa·s to about 2000 mPa·s up to 7 days after preparation.

14. The composition of claim 13, wherein the composition has a viscosity ranging from about 100 mPa·s to about 1000 mPa·s up to 7 days after preparation.

15. The composition of claim 1, wherein the composition has a solids content equal to or greater than about 60% by weight of the composition.

16. The composition of claim 13, wherein:
less than about 40% of the anions present on the polymeric dispersant are neutralized by magnesium ions;
about 60% or less of the anions present on the polymeric dispersant are neutralized by sodium ions; and
about 70% or less of the anions present on the polymeric dispersant are not neutralized by sodium or magnesium ions.

17. The composition of claim 13, wherein from about 1% to about 39% of the anions present on the polymeric dispersant are neutralized by magnesium ions.

18. The composition of claim 13, wherein from about 1% to about 60% of the anions present on the polymeric dispersant are neutralized by sodium ions.

19. The composition of claim 13, wherein the inorganic particulate material comprises calcium carbonate.

20. The composition of claim 13, wherein the anionic polymeric dispersant comprises polyacrylic acid.
